(19) United States
(12) Patent Application Publication
(10) Pub. No.: US 2003/0062313 A1
(43) Pub. Date: Apr. 3, 2003

(54) Method of improving the quality of liquid and its device

(76) Inventor: Sadao Oka, Osaka (JP)

Correspondence Address: MOONRAY KOJIMA, BOX 627, WILLIAMSTOWN, MA, 01267, US

(21) Appl. No.: 10/078,748

(22) Filed: Feb. 19, 2002

(30) Foreign Application Priority Data
Jan. 15, 2002 (JP) 2002/005,864
Mar. 1, 2001 (JP) 2001/056,466

(51) Int. Cl. C02F 1/30; C02F 1/48

(52) U.S. Cl. 210/695; 210/748; 210/243; 210/222

(57) ABSTRACT

The present invention relates to the art of making the required liquid out of various liquids like water of ponds, lakes, marshes, the rivers, life waste water and industrial water, rain water, underground water, urine, sea water, aqueduct water, improving the quality of these waters to a required level that allows them to be discharged, and used for growing plants and breeding fishes and shells, and to a higher lever allowing them to be drunk while providing good health to the human body, wherein the liquid to be processed will be improved both by the filtering step for passing the liquid through the filtering material and the magnetic process for passing the liquid through the magnetic field and wherein the said liquid will be refluxed to the said filtering material and/or to the reserving part for reserving the said liquid upon being processed and also relates to the method of improving the quality of liquid and its device, whereby, during the said reflux, the said liquid is to be sprayed upon being processed for improvement.

### BACKGROUND OF THE INVENTION

1. Field of the Invention

The present invention relates to the art of making the required liquid out of various liquids like water of ponds, lakes, marshes, the rivers, life waste water and industrial water, rain water, underground water, urine, sea water, aqueduct water, improving the quality of these waters to a required level that allows them to be discharged, and used for growing plants and breeding fishes and shells, and to a higher lever allowing them to be drunk while providing good health to the human body

2. Prior Art

As an art of purifying the dirty water, there is disclosed, for example, a device disclosed in the Japanese Patent Published for publication No.327695(Heisei 9, 1997). This purification device of water comprises the magnetic process device for magnetizing the original water and the filtering material for filtering water while allowing the microbes useful for the purification of water to live, and wherein original water is activated by the magnetizing device to be filtered and then brought back to the original water.

On the other hand, this device is only capable of getting rid of trash from the original water, which trash is visible by providing a filter on the forward step of the magnetizing device, however, the magnetizing procedure is limited thereto and the effects of activating water by the magnetizing step are hard to obtain thoroughly. Therefore, the said device is not apt for purifying the large amount of original water, which is extremely dirty like water of lake and marshes.

Furthermore, the filtering material to be used is made of plastic and not apt for improving the quality of water effectively and thus, its effect of purification is bad. In addition, the frequent flowing back and exchange of the filtering material is indispensable. Furthermore, the said device can only be used for the purification of slightly dirty water and its scope of use is limited.

### SUMMARY OF THE INVENTION

The main object of the present invention is to purify a large amount of water in an effective way even though it is extremely dirty such as water of lake and marshes, with the sufficient effects of magnetizing. On the other hand, besides purification of dirty water, it is intended to improve the quality of various liquids, for instance, manufacturing water, which is good for the human body and the nature.

In other words, the quality of water is improved by the filtering step of passing the liquid to be processed through the filtering material and the magnetizing step of passing the said liquid through the magnetic field, wherein the said liquid will be refluxed to the said filtering material and to the reserving part for reserving the said liquid to be processed upon the said improvement of the quality of water and during the said reflux, there is provided a method of improving the quality of water by spraying the liquid to be processed upon the said improvement of the quality of water.

Furthermore, there is provided the device for improving the quality of water comprising the filtering device for passing the liquid to be processed through the filtering material and the magnetic device for passing the material to be processed through the magnetic field and in the rear step of the said device for improving the quality of water there is provided a reflux path for refluxing the liquid to be processed to the said filtering device and/or to the reserving device for reserving the said liquid to be processed and on the tip of the said reflux path there is provided the device for improving the quality of liquid formed with the spraying means for spraying the liquid to be processed.

The said filtering device and magnetizing device and the filtering material and the magnetizing material are installed in an appropriate condition (for instance, processing methods, order, step, combination of each step) corresponding to the condition of the liquid to be processed and the improving condition to be achieved. For instance, for purification of the dirty water, the magnetizing step should be done after the filtering process. In order to improve the quality of upper water, the direct magnetizing process can be carried out.

For the magnetizing process, the well-known structure may be used, wherein the permanent magnet is formed and the clusters (unit of particles) will be turned into fractions for activation upon passing the water through the magnetic field.

For the filtering process, the filtering materials in the form of particles which are porous may be used for getting rid of the harmful elements and its absorption and discharging the effective elements besides the textile-made filter for filtering the solid objects and the filter in the form of wires and other appropriate filter like ceramic filter. Specifically, when the far infra red emission is used as the filtering material, the energy level of the liquid to be processed can be elevated so that the effect of activation can be improved by the magnetic process.

In other words, according to the above-mentioned construction, the liquid to be processed will be subject to the filtering process and by passing through filtering material, unnecessary trashes will be removed. In addition, when natural minerals and materials which discharge effective elements are used, its energy level will be heightened and activated and occasionally minerals are added so that respective effects can be given thereto according to the filtering material to be used. Furthermore, when the liquid to be processed is subject to the magnetizing step, the clusters of the liquid to be processed are turned into fractions to make particles, thus leading to activation. Thus, unnecessary trashes merged into the clusters will be disgorged while elevating the density of the clusters so that they will be subject to the magnetic effect. In this step of improving the quality of liquid, the filtering step and the magnetic step can be carried out so that the effective and the high level improvement can be obtained by the mutually increasing effects which cannot be gained by either one of them.

Furthermore, after the improvement of quality of water is made, the liquid to be processed will be discharged in case of a necessary use upon improvement or returned to the part where the liquid to be processed is reserved while purifying and activating the said part and otherwise, the said liquid to be processed will refluxed to the filtering material for filtering the liquid and afterwards, the filtering material and the liquid to be processed, located nearby will be purified and activated. The reflux is made by spraying and the liquid to be processed and the filtering material are thrown against each other or one liquid to be processed is thrown again another strongly. In this way, the clusters of the liquid to be processed, which have been turned into corpuscles will be turned into fractions to make super-corpuscles so that high precision can be obtained, leading to the higher level of activation while cleaning up the filtering material. As a result, the filtering material does not have to be exchanged unnecessarily while sparing time and efforts.

In addition when the liquid to be processed is refluxed to the filtering material, the reverse flowing can be carried out as for the washing of the filtering material. In other words, the washing of reverse flowing means the step of removing the trashes from the filtering material by flowing the liquid reverse against the direction of the liquid to be processed during the improvement of the quality of the liquid. This step of reverse flowing for washing may be carried out as explained above by spraying the liquid so that the filtering material will be washed clean and more subject to the effects of the filtering material than in case the said liquid to be processed flows simply adjacent to the filtering material. Especially, the liquid, which is activated after the clusters have been turned into fractions, shows the high mobility and thus, solving many materials so that the filtering material will be kept clean besides the liquid being thrown against each other. Furthermore, when the filtering material comprises natural stones apt for giving effects to the liquid, they should be well solved, providing for effective elements in an effective way. As a result, the clusters of the liquid to be processed will be turned into more minute corpuscles (activation) than in case of ordinary liquid thrown against each other, thus allowing the liquid to be improved as required in respect of quality.

In this way, the efficiency of the improvement of the quality of liquid is so good that a large amount of extremely dirty water can be sufficiently purified. Also, the care and maintenance such as exchange of filtering materials are unnecessary.

Another object of the present invention is to provide easily the suitable device in accordance with the condition of the liquid to be processed and the purpose of the improvement of the quality of water.

In other words, on the forward step and/or the rear step of the said device for improving the quality of the liquid there is provided the device of magnetic procedure for passing the liquid to be processed through the magnetic field, wherein the device for improving the quality of liquid comprises the magnetic field becoming gradually stronger as it is nearer to the rear step in respect of the magnetizing material of the said magnetizing device and the said device for improving the quality of liquid.

Therefore, according to the above said construction, the device for improving the quality of liquid comprises the material for improving the quality of liquid having the filtering material and the magnetizing material and a reflux path and the spraying means, together with the magnetizing device connected if necessary, so that it will be used for various occasions and various uses. Furthermore, the magnetizing device is connected in such a way that the magnetic field becomes stronger as it is closer to the rear step and that, in accordance with the flow of the procedure, the stronger magnetic field operates. Therefore, the liquid to be processed will be brought to a higher state of activation in a gradual but steady way.

On forward and/or rear step of the said device for improving the quality of liquid there may be connected the assisting device for processing the liquid in accordance with the required condition of liquid so that the required effects can be made to the liquid to be processed according to the said device. For the assisting devices, there are, for example, a device having a filtering material and a magnetizing material together with the said device for improving the quality of liquid and also a device for sterilizing and a device for precipitation. As the best option, dirty water like urine and excrements can be cleaned and alternatively, the quality of the drinkable water can be procured and heightened to a better function.

Other objects of the present invention will be clarified according to the examples as set forth below.

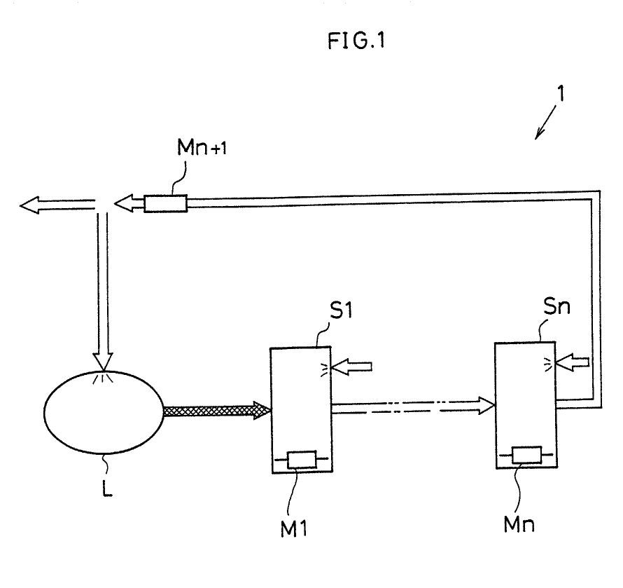

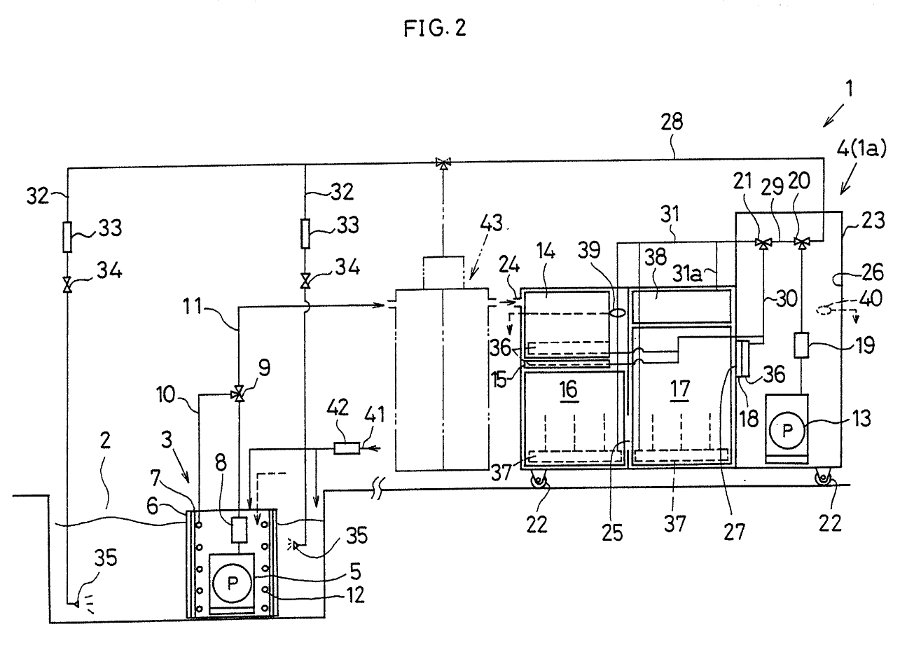

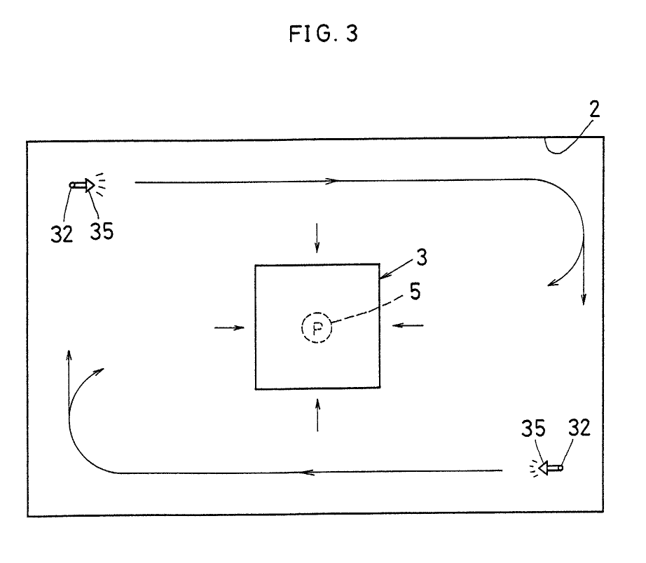

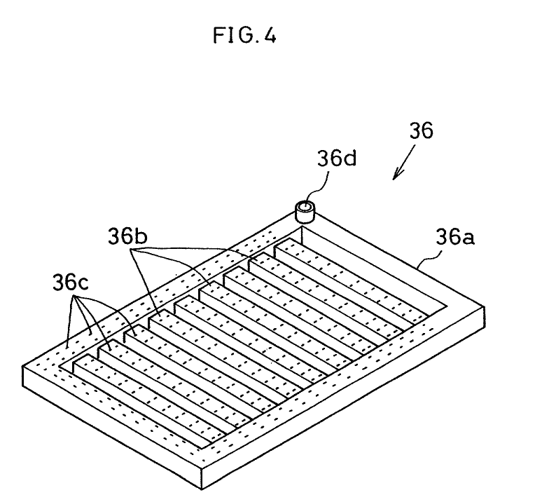

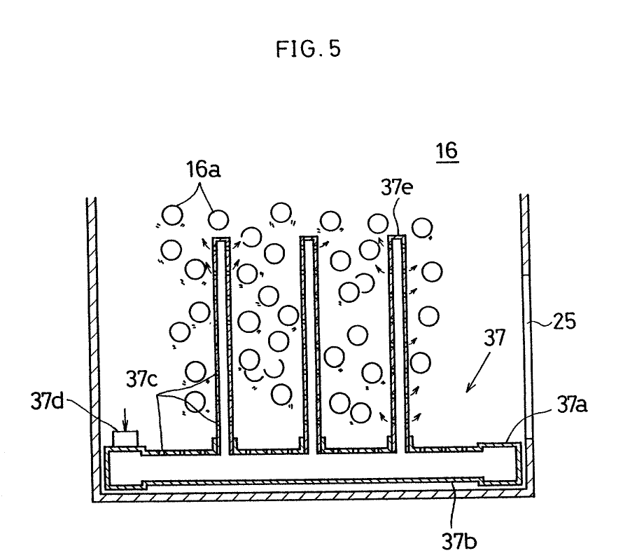

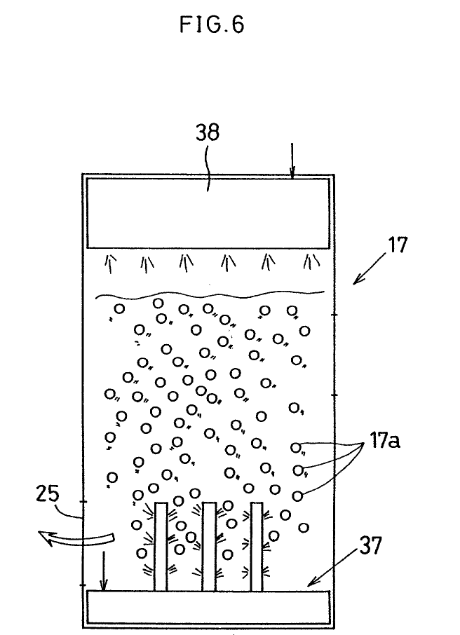

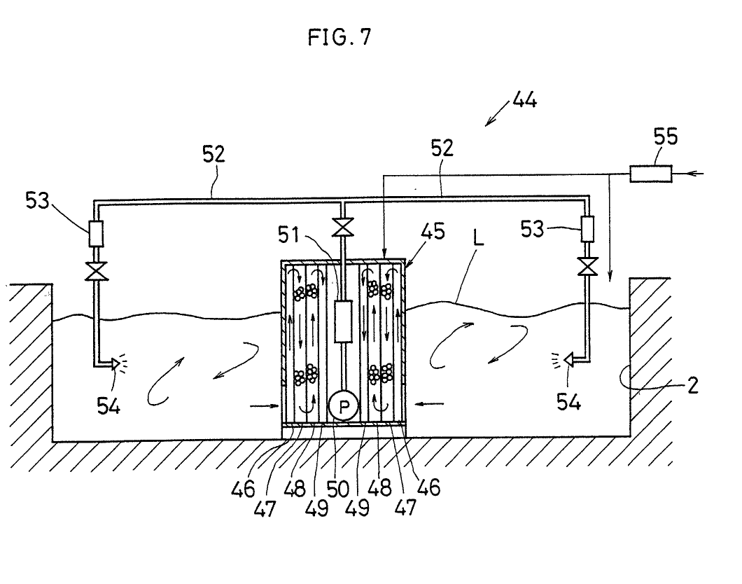

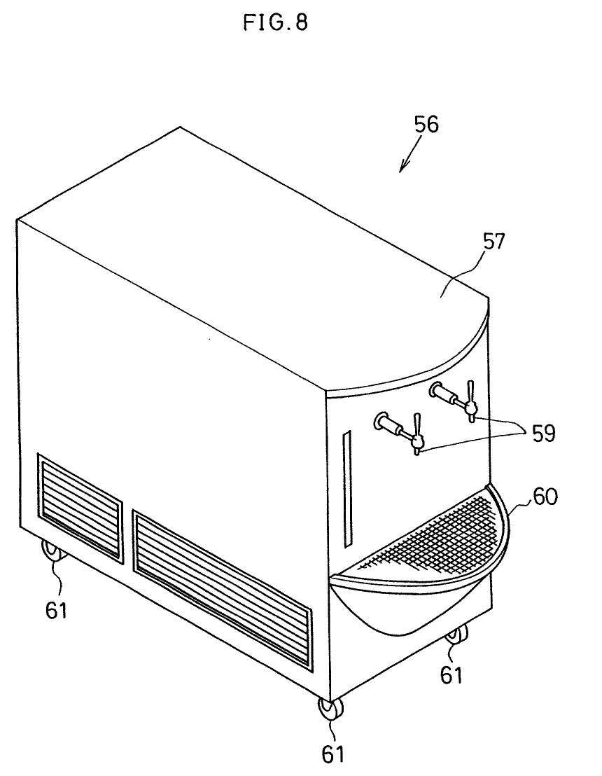

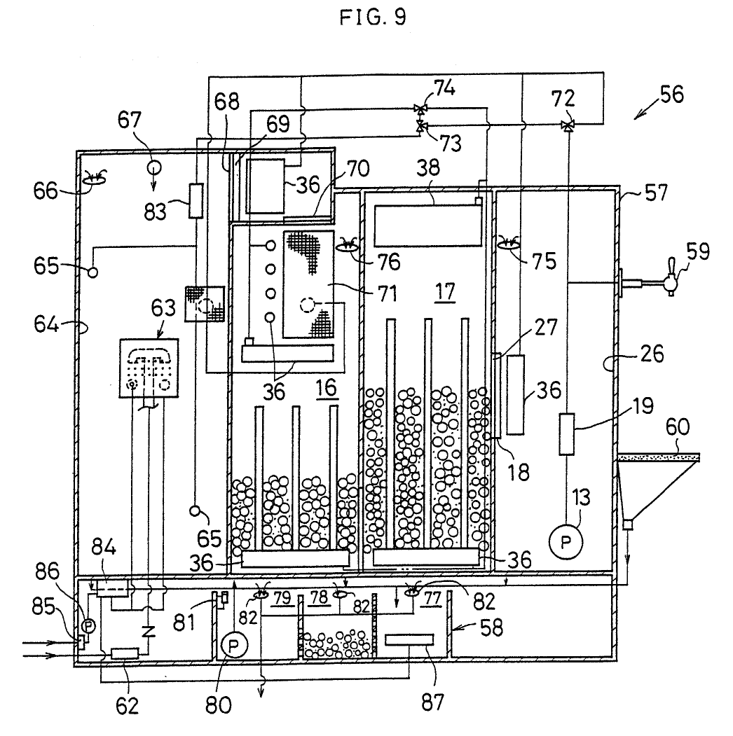

### BRIEF EXPLANATION OF THE DRAWINGS

[FIG. 1] Explanatory view showing the schematic plan of the device for improving the quality of liquid

[FIG. 2] Structural view of the device for improving the quality of liquid according to the example 1.

[FIG. 3] Plan view of the first device for improving the quality of liquid being in function.

[FIG. 4] Squint view of the spraying material

[FIG. 5] Explanatory view of the spraying material and the condition in which it operates.

[FIG. 6] Explanatory view of the filtering layers in washing.

[FIG. 7] Structural view of the device for improving the quality of liquid according to the example 2.

[FIG. 8] Squint view of the device for improving the quality of liquid according to the example 3.

[FIG. 9] Structural view of the device for improving the quality of liquid as in the FIG. 8.

### PREFERRED EMBODIMENT

One embodiment of the present invention will be clarified using the below drawings.

The FIG. 1 is an explanatory view showing the schematic view of the device for improving the quality of liquid, wherein each type of the liquid to be processed L will be activated by the magnet for the improvement of quality and the liquid will be exhausted upon the process of improvement while the said liquid will be returned to the liquid to be processed L for its improvement and the liquid may be refluxed to the said material S1, Sn for improving the quality of liquid so that the liquid to be processed will be more activated (improved in terms of quality), allowing the material S1, Sn for improving the quality of liquid to be cleaned. In the figures, M1, Mn, Mn+1 are the magnetizing device for magnetizing the liquid.

The said material for improving the quality of liquid S1, Sn may be provided with a plurality of steps according to the condition of the liquid to be processed L and the intended condition of the liquid to improved. In this case, the intensity of the said magnetizing device M1, Mn, Mn+1 is set to become gradually stronger as it gets closer to the rear side of the device.

The above said reflux will be carried out by spraying the liquid to be processed, which has passed through the material S1, Sn for improving the quality of liquid, thus elevating the effects of improvement while having the liquid thrown against each other.

(Example 1)

The FIG. 2 is the structural view of the device for improving the liquid, intended for purifying the water of rivers, ponds, lakes and marshes, underground water and ponds for breeding fishes. According to the present device 1 for improving the quality of liquid, dirty water will not only be cleaned but also made capable of getting clean by itself.

The device 1 for improving the quality of liquid as shown in the FIG. 2 comprises the first device 3 for improving the quality of liquid installed inside the reserving part 2 where the water to be purified is reserved and the second device 4 for improving the quality of liquid, which can be installed in the factories and other places.

In other words, according to the first device 3 for improving the quality of liquid, water is pumped up by the pump 5 and passed through the first filter layer 6 and the first filtering layer 7 corresponding to the filtering material of the present invention in the order specified here so that the water is subject to the magnetic process of the first magnetizing device 8. The first device 3 for improving the quality of liquid may be formed in an appropriate form capable of being included in the reserving part 2. According to the drawing example, the said device may be formed like a rectangular parallelepiped box constructed in a manner that allows water to be pumped up from four sides, provided with the said first filter layer 6 and the first filtering material 7 along each side. The said pump 5 is situated in the center so that it is surrounded by the said first filter layer 6 and the first filtering material 7.

The above said first filter layer 6 is used for separating the trashes or coagulated floating objects from water, being composed of the well known filter like fibrous filter and the filter in the form of stainless mesh with fine nets.

The first filter layer 7 is used mainly for improving the quality of water, discharging effective elements like far infra-red radiation ceramics, hydrated silicic acid stones and cooked barley-like stones, sodalite and being formed by filling natural stones for absorbing and removing harmful components. The filtering material may be formed of far infra-red radiation ceramics only or natural stones only, however a combination of both of these materials are effective for recovering the original state of water. In addition, tender porous ancient humus soil, coal rock (calcium), metamorphic granite (various minerals) and sulfuric steel (magnet) may be used to obtain good mineral water suitable for drinking.

Far infra-red radiation ceramics and natural stones may be formed in a globe of one centimeter diameter and when water passes through them, activation by heat absorption, absorption or separation by many fine pores on the surface of the natural stones are made while exchanges of ions, coagulation of objects floating on water, which objects have been melted out, sterilization, anti-bacterial process, deodorization are carried out.

The said first magnetizing device 8 has a well known structure, being composed of a eternal magnet and by passing through the magnetic field, the clusters of water will be turned into fractions to be activate.

In the rear step of the said first magnetizing device 8, there is provided the first direction-shifting valve 9, wherein water passing through the first magnetizing device 8 will be refluxed to the inner position of the said first filtering layer 7 by the reflux path 10, together with the sending path 11 for sending water to the second device 4 for improving the quality of liquid. On the tip of the reflux path 10, there is provided the spraying material 12 for spurting out water, so constructed that the first filter layer 6 and the first filtering layer 7 can be cleaned by the refluxing water when flowing back. The spraying material 12 may be in a condition which allows water to pass freely between the first filtering layer 7 and the pump 5, wherein the first filtering layer 7 comprises many small pores.

The second device 4 for improving the quality of liquid is so constructed that water carried by the pump 13 passes through the first filter 14 layer, the second filter layer 15, the first filtering layer 16, the second filtering layer 17, the third filtering layer 18 in this respective order and finally will be magnetized by the second magnetizing device 19. Furthermore, the first direction shifting valve 20 and the second direction changing valve 21 are provided so that the magnetized water will be refluxed to each of the said filter layers 14, 15, 18 and each filtering layers 16, 17 in order to clean each part by flowing back.

The whole part of the second device 4 for improving the quality of liquid is to be included inside the encasing box 23 having the moving means 22 like casters on the below side.

The encasing box 23 is largely divided into three parts along its length and on the upper side of the first compartment of the end part there is provided the supplying outlet 24 for connecting the sending path 11 from the said first device 3 for improving the quality of liquid and where water supplied from the supplying outlet 24 is received on the upper part of the first compartment, there is provided the said first filter layer 14 comprising, for example, stainless mesh basket and the fibrous filters. Furthermore, the said second filter layer 15 is provided, which comprises stainless meshes finer than those of the first filter layer 14.

Beneath the second filter layer 15 there is formed the first filtering layer 16. This first filtering layer 16 is used for mainly improving the quality of water in the same manner as the first filtering layer 7 in the above said first device 3 for improving the quality of liquid, comprising the far infra-red radiation ceramics in the form of a globe, wherein the said layer is filled up with appropriate natural stones being used as filtering material. The filling-up will be done inside the determined space to a degree that allows the filtering materials to be floated. (See the FIG. 5.)

Adjacent to the first filtering layer 16, or beneath the second compartment there is formed the said second filtering layer 17 through the connecting outlet 25. This second filtering layer 17 is also filled up with the far infra-red radiation ceramics formed with many particles and the natural stones being used as filtering materials in the same way as the first filtering layer 16 and the types of the contents and combination ratio may be the same as the first filtering layer 16 or may vary according to the necessities.

Furthermore, in the third compartment adjacent to the second compartment in which the second filtering layer 17 is located, there is provided the pure water tank 26. From the second filtering layer 17 the water flows into the pure water tank 26 through the connecting outlet 27 formed on the side of the upper part and through the said third filter layer 18. This third filter layer 18 is also composed of filters, for example, in the form of stainless meshes.

The pure water tank 26 is provided with the said pump 13 for pumping up the reserved water, wherein there is provided the said second magnetizing device 19 for magnetizing the water pumped up by the pump 13. This second magnetizing device 19 has an effect of having a stronger magnetic field than the first magnetizing device 8 of the first device 3 for improving the quality of liquid.

On the tip of the said second magnetizing device 19 there is provided the said first direction changing valve 20 to form the reflux path 28 for turning back the water to the reserving part 2 and the connecting path 29 to connect to the said second direction changing valve 21. There are formed two types of the reflux paths 30, 31 from the second direction changing valve 21. The first reflux path 30 of them allows the liquid to reflux to each of the filter layers 14, 15, 18 in order to clean each of the filter layers 14, 15, 18 while flowing back. The other second reflux path 31 allows the liquid to reflux to each of the filtering layers 16, 17, wherein each of the filtering layers 16, 17 will be cleaned up during the flowing back of the water.

The reflux path 28 extending from the said first direction changing valve 20 leads to the reserving part 2, forming a plurality of discharging paths 32. On each of the paths 32 there are provided the third magnetizing device 33 and the water-volume adjusting valve 34, wherein on the tip of them there is installed the spraying member 35, which is similar to the well known nozzle.

For the above third magnetizing device 33, the device whose magnetic field is stronger than the second magnetic device 19 located on the forward step of the device 33 is used. Furthermore, each spraying member 35 inside the reserving part 2 is located in an appropriate position in respect of the height of installation and location on the plane surface so that water inside the reserving part 2 is well mixed by the water sprayed from the spraying member 35. (See the FIG. 3.)

Each member is provided with the spraying member for spraying water, wherein the said washing of flowing back is done by spraying in the reverse direction in respect of the ordinary flow of the water.

The spraying member 36 for the washing of each filter layers 14, 15 and 18 during the flowing back may be formed, for example, as in the FIG. 4. In other words, the frame 36 a is provided in the same size as or roughly corresponding to the washing surface of the filter layers 14, 15 and 18, wherein, inside the frame 36a there is formed a plurality of bridges 36b. Both frame 36a and the bridge 36b are empty inside and on the upper surface of the frame 36a and the bridge 36b there are formed many small pores 36c. Also, in one part of the frame 36a there is formed the connecting part 36d to connect the tip of the first reflux path 30. Water enters inside from the connecting part 36d and will be sprayed vehemently from many pores 36c so that each filter layer 14, 15 and 18 will be washed clean even in its fine holes. Other appropriate spraying members may be used.

The spraying member 37 for washing each filtering layers 16, 17 while flowing back comprises the frame 37a and the bridge 37b in the same way as the said spraying member 36, wherein a plurality of bridges 37b have a plurality of columns 37e installed on the upper surface as shown in the FIG. 5. There are installed many small pores 37c on the surface of each columns 37e and the upper surface of a plurality of the bridges 37b and the frame 37a so that water will be vehemently sprayed out from these small pores 37c.

Then many filtering materials 16a, 17a, which can be floated, move around by force of the water flow so that water will be thrown against each other between the filtering materials 16a and 17a and the filtering materials 16a and 17a will be beaten against each other.

On the upper part of the second filtering layer 17 provided with the said spraying member 37 there is provided the washing tank 38 for washing while flowing back. The washing tank 38 while flowing back is connected to the tip of the branch path 31a provided on the said second reflux path 31, wherein water flowing from the said branch path 31a is to be reserved to be pressed and sprayed down and it operates to push trashes and floating objects separated from the filtering materials 16a and 17a back into the first compartment by washing during flowing back from the said spraying member 37 as shown in the FIG. 6.

In the said first compartment, the overflow outlet 39 is formed to exhaust water, which has been pushed up, together with trashes. Water, thus exhausted, may be discharged as it is or carried to the reserving part 2. Not only water flown out but also trashes are activated so that water inside the reserving part 2 may not be made dirty or rather help activation.

The overflow outlet 40 is also provided on the pure water tank 26 and water coming from the said overflow outlet 40 may be exhausted as it is or be carried into the reserving part 2 and other parts.

The system 1 for improving the quality of liquid thus constructed is intended to improve the quality of water as follows.

Thus, the dirty water inside the reserving part 2 enters the first device 3 for improving the quality of liquid to be improved for the first time. Water passing through the first filter layer 6 and the first filtering layer 7 respectively will have trashes separated by the first filter layer 6 and others first. In the next step, the first filtering layer 7 will receive the far infrared radiation to cause resonance reaction between water molecules so that separation of water molecules will be promoted while increasing its activation. Furthermore, elements of the natural stones will be melted out to coagulate the impure objects or take out minerals while getting rid of odors so that various effects may influence according to the contents of the filtering materials.

The improved water, thus processed, will be subject to the magnetizing process by the first magnetizing device 8. By this effect of magnet, the clusters of water will turn into fractions to become corpuscles. On the other hand, when turning into fractions, the impure objects melted down into the clusters will be spurted out to make more pure state and get activated.

Water, whose quality has been improved in the first step will be moved to the second device 4 for improving the quality of liquid while being refluxed to the spraying member 12 installed inside the said first device 3 for improving the quality of liquid after passing through the reflux path 10.

This reflux (washing during the flowing back) may be done between predetermined hours or may be carried out automatically when the first filter layer 6 has their pores shut, thus according to the necessities. Both the first filter layer 6 and the first filtering layer 7 will be cleaned out by washing of flowing back, wherein water is very subject to the effects of the filtering materials as water and filtering materials are beaten against each other.

Water moved to the second device 4 for improving the quality of liquid passes through the first filter layer 14, the second filter layer 15 in their respective order to be highly filtered and get reserved in the first filtering layer 16. In the first filtering layer 16 there is water contact with the filtering materials to have effects of the filtering material 16a, thus increasing the active power by the promotion of the separation of water molecules and when the elements of natural stones are melted out, the impure objects get coagulated or minerals are fed or odors are removed and thus various improvements will be effectuated. The second filtering layer 17 adjacent to the first filtering layer 16 further purifies and activates upon improvement of the liquid.

Water thus improved, passes through the third filter layer 18 to the pure water tank 26 and will be pumped up by the pump 13. Upon pumping up, the improved liquid will be magnetized by the second magnetizing device 19. Water once purified and activated will be more activated by the magnetizing process in the magnetic field stronger than the process carried out by the said first magnetizing device. In other words, the clusters will continue to turn into fractions to become super-corpuscles. As a result, fluidity will increase while solubility will be elevated, recovering the original function of water itself if it ever exists. Magnetized water with super molecules like this has various effects in order to maintain its original high function. For instance, activation of the liquid, which is poured, control of the scales and rust inside the aqueduct, dissolution of the impure objects having been filtered, prevention of the dirt in the water, washing effects by improving the penetration and solubility, cutting down on time for boiling water by improving the fluidity and heat conductivity and removal of organic matters and heavy metals and other various effects can be obtained. Furthermore, when drinking, the water becomes tasty and tea and foods become also delicious and when giving it to the plants and animals, it will help them grow sound. Water activated by super corpuscles passes through the reflux path 28 and will be returned to the reserving part 2 while the water will be refluxed to each of the filter layers 14, 15, 18 and each filtering layers 16, 17 for washing during flowing back.

Water flowing back to the reserving part 2 is more activated by the third magnetizing device 33 and sprayed to the reserving part 2. The sprayed stream mixes the water inside the reserving part 2 and even the soil in the reserving part 2 if it ever exists. By an active spraying of the pure water, the said stream beats the soil and water vehemently, promoting the step of turning into fractions of the clusters while activating the water inside the reserving part 2 and giving effects to water in other parts. In other words, removal and separation of organic matters of the soil and heavy metals, prevention of the dirt in water and algae from arising and prevention of corruption and various good effects can be obtained. In addition, by the mixing step, the water stream arises, thus promoting reactions while elevating the efficiency of the procedure.

Furthermore, for the improving procedure, no screw is to be used and thus, even though fishes and plants are inside, extremely natural procedures can be carried out.

Water refluxed through two reflux paths 30, 31 washes off against the purified and activated water in the reverse direction as in the case of the above said first device for improving the quality of water, thus cleaning up the filter layers 14, 15, 18 and the filtering layers 16, 17. In time of washing the filtering layers 16, 17 while flowing back, there is provided the reverse washing tank 38 from which reverse washing tank 38 water is made to flow vehemently. Thus, water is to splash strongly both from up and down, while promoting the activation of water so that the filtering materials can be effectively cleaned. In addition, according to the construction, the dirt arisen from the said reverse washing can be discharged from the overflow outlet 39 and while being discharged from the device, the improvement of the quality of liquid can be done again. In the FIG. 2, 41 is the pouring path for feeding water which has been discharged from the overflow outlet 39 during the above-mentioned step and when the magnetizing device is installed therein, the water can be activated and thus, the improvement of quality of water can be readily done. The reserving part 2 may be a pond and when there is water entering it, the same effects can be obtained.

Thus, as water inside the reserving part 2 circulates around the first device 3 for improving the quality of liquid and the second device 4 for improving the quality of liquid, it gets clear and will be made to return after being cleaned. In fact, the water will not only be made to return, but also the returned water cleans up water and removes the dirt and filthy things. In addition, the filter layers 14, 15, 18 to remove the dirty and the filtering layers 16, 17 are cleaned by the water stream, which has been purified.

Therefore, being different from the purifying effects to simply remove the dirt, the device of the present invention is capable of improving the quality of water very effectively. It can also activate water already improved and it will never get dirty again in a short period of time. The said device will be kept clean for a long period of time.

Also, each device for improving the quality of liquid can do without special maintenance. Furthermore, as chemical agents are not being used, it is good for the environmental protection.

On the other hand, depending on the condition of improvement to be achieved or the dirt of the reserving part 2, an appropriate assisting device 43 may be connected between the first device 3 for improving the quality of liquid and the second device 4 for improving the quality of liquid as shown in the FIG. 2 with a virtual line. This assisting device 43 may be constructed similar or in the same way as the above said devices 3, 4 for improving the quality of liquid, for example, and it may serve as the sterilizing device or as the device for precipitation and according to its use, a necessary device may be connected.

Furthermore, appropriate forms may be adopted according to the place in which to use in respect of the devices 3, 4 for improving the quality of liquid. For instance, when the reserving part is deep and wide, this must be composed of a flowing material to be floated on the surface of water.

By using the device 1a for improving the quality of liquid, which is included in the encasing box 23 like the said second device 4 for improving the quality of liquid, the said device can easily be installed in any place, like in the buildings, water supplying installations of the houses or with the circulatory freezing device, thus attaining the effect of being easy to install. When the encasing box 23 is provided with the means of transference 22, it can move to other places.

(Example 2)

The device for improving the quality of liquid for purifying the water of rivers, ponds, lakes, marshes, underground water, water of ponds for breeding fishes may be constructed as shown in the FIG. 7. This refers to the device 44 for improving the quality of water, which can be included in the reserving part 2, where the liquid to be processed exists.

In the figure, 45 is the processing tank in the form of the rectangular parallelepiped box, comprising from the outer part, the first filter layer 46, the first filtering layer 47, the second filtering layer 48 and the second filter layer 49. Furthermore, the liquid L to be processed pumped up by the pump 50 installed in the center will be made to pass through the first magnetizing device 51 in order to be more activated by the second magnetizing device 53 installed in the reflux pipe 52 with a plurality of branches so that the said liquid will be mixed by spraying it into the reserving part 2 through the spraying material 54. Each filter layer and the filtering layer is composed in the same way as in the example 1 and for each magnetizing device, the one whose magnetic field is becoming stronger as it is closer to the rear step side may be used. In the FIG. 55, there is shown the magnetizing device for activating the water to enter the reserving part 2.

When the device 44 for improving the quality of liquid is thus constructed, it is possible to improve the quality of water in the pond, for example.

(Example 3)

The FIG. 8 is the squint view of the device 56 for producing highly functional water, capable of presenting highly capable water, which is good for health and tasty and the FIG. 9 is the structural view of the device 56 for producing highly functional water.

In other words, the said device 56 for producing highly functional water is provided with the overflow tank 58, wherein water flown out of each improving device and also in time of supplying from the supplying faucet 59, water spilt on the supporting part 60 is recovered so that it will be utilized effectively. Furthermore, below the encasing box 57 there is installed the means of transference, apt for moving the device.

As for the construction of the device 56 for producing highly functional water, the same signs are put and more detailed explanation will be omitted in respect of the same parts as in the above-mentioned example 1.

The device 56 for producing highly functional water comprises roughly five compartments, that is to say, the first compartment, the second compartment, the third compartment, the forth compartment respectively and below them there is formed the fifth compartment.

First of all, the first compartment sterilizes the supplied clean water in the first device for improving the quality of water upon magnetizing of the first magnetizing device 62.

The sterilizing step may be done according to the appropriate method and in this case, the sterilizing device 63 is being used with ozone, which device is installed in the reserving tank 64.

On the other hand, the reserving tank 64 is formed with the discharging outlet 65 for discharging the refluxed water and the overflow outlet 66 for discharging water and the water outlet 67 for recovering water over flown, wherein on the upper side adjacent to the second compartment, there is formed the connecting outlet 68.

The above said second compartment, the third compartment and the fourth compartment belong to the said second device for improving the quality of liquid, which device is constructed roughly in the same manner as the device la for improving the quality of liquid as in the above-mentioned example 1.

At first, in the said connecting part 68 on the upper part of the second compartment there is provided the first filter layer 69. This first filter layer 69 is formed with the appropriate filter like stainless meshes. The number 36 in the figure is the spraying member for washing the first filter layer during the flowing back.

On the rear step for the first filter layer 69 there is provided the second filter layer 70 whose pores are finer than that and below the second filter layer 70 there is provided the third filter layer 71 for filtering the water flowing down.

The third filter layer 71 is formed in the rectangular parallelepiped basket, wherein the spraying member 36 is provided for washing during the flowing back. Below the third filter layer 71 there is the first filtering layer 16 and adjacent to it there is the second filtering layer 17. Above the second filtering layer 17, there is provided the tank 38 for washing during the flowing back of water.

Water passing from the second filtering layer 17 through the connecting outlet 27 flows into the pure water tank 26 through the fourth filter layer 18.

The water reserved in the pure water tank 26 is to be pumped up by the pump 13 and after being magnetized, passing through the second magnetizing device 19, the said water will be supplied from the water supplying faucet 59. Furthermore, by three direction shifting valves 72, 73, 74, the liquid will be refluxed to the reserving tank 64 and the washing of flowing back will be done by each of the said filter layers 69, 71, 27 and the filtering layers 16 and 17. The number 75 in the upper part of the pure water tank 26 and the number 76 in the upper part of the first filtering layer 16 are the overflow outlets.

The above-mentioned overflow tank 58 comprises three parts, that is to say, the sterilizing place 77 connecting to each part, the cell 78 for getting rid of the odor of ozone having been used for the sterilization and the reserving cell 79 for reserving water to be returned to the said reserving tank 64. The cell 78 for getting rid of the odor is filled, for example, with anti-bacterial balls, charcoals and bamboo coals, etc. The reserving cell 79 is provided with the pump 80, together with the float-switch 81. Furthermore, each of the said part is provided with the overflow outlet 82, discharging the flown out water out of the device. In the figure, the number 83 is the magnetizing device, while the 84 is the ozone-causing device and the 85 is an air-filter and wherein the 86 is the pump and the 87 is the sterilizing device.

According to the device 56 for producing highly functional water, thus constructed, the pump 13 is driven to improve the liquid and highly functional water can be obtained. The washing during the flowing back is carried out in convenient time using the timer and the float-switch 81 installed on the overflow tank 58 can be used to do it conveniently.

Highly functional water, thus obtained, is the water having the proper function characteristic of water and by effects of natural stones many minerals are contained. It becomes super-molecule mineral magnetic ion water to get very mild and tasty water. The water gets not only tasty but also has various effects, like having capacities to activate the human bodies and other living things.

1. The method of improving the quality of liquid, wherein the liquid to be processed is improved by passing through the filtering materials to be filtered and the magnetic field to be magnetized and wherein the said liquid to be processed will be refluxed to the said filtering materials and/or to the reserving part for reserving the said liquid to be processed upon the said improvement of the liquid and during the said reflux the liquid to be processed is sprayed upon the said improving procedure.

2. The method of improving the quality of liquid according to the claim 1, wherein the liquid is magnetized in the forward and/or the rear step of the said improving procedure and the magnetic field is stronger as it gets closer to the rear step for magnetizing.

3. The device for improving the quality of liquid, provided with the filtering device for passing the liquid to be processed through the filtering materials and through the magnetic field for magnetizing and with the reflux path for refluxing the said liquid to be processed to the reserving part and/or to the said filtering device upon improvement of the liquid on the rear step of the said improving device, wherein on the tip of the said reflux path the means for spraying the liquid to be processed is provided.

4. The device for improving the quality of liquid according to the claim 3, wherein the said filtering device is formed by filling with many far infrared radiation objects in the form of the particles.

5. The device for improving the quality of liquid according to the claim 3, wherein the magnetizing device for passing the liquid to be processed through the magnetic field is installed on the forward and/or the rear step of the said device for improving the quality of liquid and wherein the magnetic field is set to become stronger as it is closer to the rear step of the said magnetizing device and the magnetic device of the said device for improving the quality of liquid.

6. The device for improving the quality of liquid according to the claim 4, wherein the magnetizing device for passing the liquid to be processed through the magnetic field is installed on the forward and/or the rear step of the said device for improving the quality of liquid and wherein the magnetic field is set to become stronger as it is closer to the rear step of the said magnetizing device and the magnetic device of the said device for improving the quality of liquid

7. The device for improving the quality of liquid according to the claim 5, wherein the assisting device for processing the liquid according to the required condition of improvement is connected on the forward and/or rear step of the device for improving the quality of liquid described in the claim 3.

8. The device for improving the quality of liquid according to the claim 6, wherein the assisting device for processing the liquid according to the required condition of improvement is connected on the forward and/or rear step of the device for improving the quality of liquid described in the claim 4.

9. The device of claim 5, wherein an assisting device for processing liquid according to a required condition of improvement is connected to said forward and/or rear step of said device.

10. The device of claim 6, wherein an assisting device for processing liquid according to a required condition of improvement is connected to said forward and/or rear step of said device.
